(19) United States
(12) Patent Application Publication
(10) Pub. No.: US 2008/0248273 A1
(43) Pub. Date: Oct. 9, 2008

(54) Polymer, Method For Producing the Polymer, Optical Film, and Image Display Device

(75) Inventors: Yasuhiro Aiki, Kanagawa (JP); Takahiro Ishizuka, Kanagawa (JP)

Correspondence Address: BUCHANAN, INGERSOLL & ROONEY PC, POST OFFICE BOX 1404, ALEXANDRIA, VA, 22313-1404, US

(73) Assignee: Fujifilm Corporation, Tokyo (JP)

(21) Appl. No.: 11/663,761

(22) PCT Filed: Sep. 22, 2005
(86) PCT No.: PCT/JP05/18052

§ 371 Date: Nov. 26, 2007

(30) Foreign Application Priority Data
Sep. 24, 2004 (JP) 2004-277291
Mar. 8, 2005 (JP) 2005-064240

(51) Int. Cl. B32B 27/00; C08F 26/06

(52) U.S. Cl. 428/220; 526/259; 428/690

(57) ABSTRACT

An optical film having a recurring unit of the following formula (1) with good heat resistance and good optical properties:

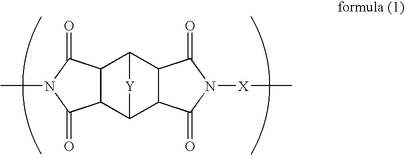

wherein X represents a divalent linking group containing a monocyclic or condensed polycyclic aromatic ring; Y represents a methylene group, an ethylene group or an ethenylene group; and X is represented by the following formula (2):

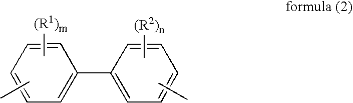

wherein R¹ and R² each represent a halogen atom, an alkyl group, an alkoxy group or an aryl group; and m and n each indicate from 0 to 4.

### TECHNICAL FIELD

The present invention relates to a polymer having good heat resistance and good optical properties, to a method for producing the polymer, to an optical film and to an image display device of good display quality that comprises the optical film.

### BACKGROUND ART

Recently, in the field of flat panel displays of, for example, liquid-crystal display devices and organic electroluminescent devices (hereinafter referred to as “organic EL devices”), using plastics in place of glass substrates is under investigation from the demand for improving the breakage resistance thereof and for reducing the weight and the thickness thereof. In particular, in the display devices for mobile information communication instruments of, for example, mobile information terminals such as mobile telephones, pocketsize personal computers and laptop personal computers, there is a great demand for plastic substrates.

Plastic substrates for use in the field of plat panel displays must be electroconductive. Accordingly, using transparent conductive substrates fabricated by forming, on a plastic film, a semiconductor film of an oxide such as indium oxide, tin oxide or indium-tin oxide, a metal film of gold, silver or palladium alloy, or a composite film comprising a combination of the semiconductor film and the metal film, as a transparent conductive layer thereon for electrode substrates in display devices is studied.

For the electrode substrates that may be used for the above-mentioned object, there are known laminate structures fabricated by laminating a transparent conductive layer and a gas-barrier layer on a plastic substrate of a heat-resistant amorphous polymer, for example, a modified polycarbonate (modified PC) (e.g., see JP-A 2000-227603, claim 7, [0009] to [0019]), a polyether sulfone (PES) (e.g., see JP-A2000-284717, [0010], [0021] to [0027]), a cyclo-olefin copolymer (e.g., see JP-A 2001-150584, [0027] to [0039]). However, even using such heat-resistant plastics could not still give plastic substrates of satisfactory heat resistance. Specifically, when a conductive layer is formed on such a heat-resistant plastic substrate and then it is exposed to a high temperature not lower than 150° C. for imparting an alignment film thereto, then there occurs a problem in that the conductivity and the gas-barrier property of the layer may greatly lower and worsen.

On the other hand, recently, substrate films are required to have heat resistance of a higher level in case where TFT is disposed in fabrication of active matrix-type image display devices. To satisfy the requirement on such a high level, for example, there is proposed a method of forming a polycrystalline silicon film at a temperature of 300° C. or lower by decomposing an SiH₄-containing gas in a mode of plasma decomposition (e.g., see JP-A 7-81919, claim 3, [0016] to [0020]). Also proposed is a method of forming a semiconductor film of a mixture of amorphous silicon and polycrystalline silicon on a polymer substrate through irradiation with energy beams (e.g., see JP-T 10-512104, pp. 14 to 22, FIG. 1, FIG. 7) (the term “JP-T” as used herein means a published Japanese translation of a PCT patent application). Also proposed is a method of forming a polycrystalline silicon semiconductor layer on a plastic substrate by providing a thermal buffer layer thereon and irradiating it with pulse laser beams (e.g., see JP-A 11-102867, claims 1 to 10, [0036]). However, these methods variously proposed for forming polycrystalline silicon films for TFT at 300° C. or lower are still problematic in that their constitutions and the apparatus they require are complicated and expensive, and therefore plastic substrate resistant to heat at 300° C. to 350° C. are desired.

In addition, the process of fabricating a polycrystalline silicon film for TFT requires some high-temperature processing steps, and therefore, even plastic substrates of good heat resistance may still have some problems if their linear thermal expansion coefficient is large in that the transparent conductive layer may peel from the substrate owing to its deformation or the resistance value of the conductive layer may increase.

Further, there is proposed a transparent conductive film that comprises a polyimide derived from an aliphatic tetracarboxylic acid anhydride (e.g., see JP-A 2003-141936). The polyimide film has good transparency, but is not still satisfactory in heat resistance for forming a high-quality polycrystalline silicon film for TFT. Accordingly, it has heretofore been desired to develop an optical film having both good heat resistance and good optical properties, but no one has heretofore succeeded in obtaining a satisfactory optical film

### DISCLOSURE OF THE INVENTION

The present invention has been made in consideration of the above-mentioned problems with the related art, and one object of the invention is to provide a polymer and an optical film having both good heat resistance enough for forming various functional layers thereon at high temperatures and optical properties. Another object of the invention is to provide a method of efficiently producing the polymer having a high molecular weight.

Still another object of the invention is to provide an image display device of good image display quality, using the above-mentioned optical film.

We, the present inventors have assiduously studied the structure of polyimide for the purpose of attaining the above-mentioned objects, and, as a result, have found that a film formed of a polymer having a specific structure has both good heat resistance and good optical properties, and have completed the present invention.

Specifically, the objects of the invention are attained by the optical film mentioned below.

[1] A polymer having a recurring unit of the following formula (1):

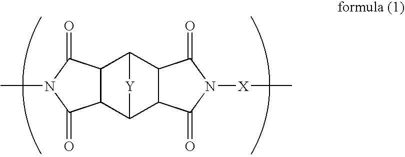

wherein X represents a divalent linking group of the following formula (2); and Y represents a methylene group, an ethylene group or an ethenylene group:

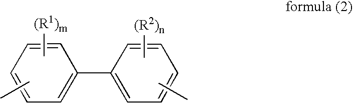

wherein R¹ and R² each independently represent at least one selected from a group comprising a halogen atom, a substituted or unsubstituted alkyl group, a substituted or unsubstituted alkoxy group, and a substituted or unsubstituted aryl group; and m and n each independently indicate an integer of from 0 to 4.

[2] A method for producing the polymer of [1], which comprises condensing a tetracarboxylic acid or its derivative with a diaminobiphenyl derivative in the presence of triphenyl phosphite especially in an organic polar solvent.

[3] An optical film comprising the polymer of [1].

[4] An image display device comprising the optical film of [3].

The polymer of the invention has low thermal expansiveness, good heat resistance and good optical properties. The optical film comprising the polymer of the invention also has low thermal expansiveness, good heat resistance and good optical properties. Accordingly, various functional films may be formed on the film of the invention at high temperatures, and, in addition to the heat resistance and the optical properties thereof, other various functions may be added to the film in accordance with its use. According to the production method of the invention, the polymer having a high molecular weight may be produced efficiently.

The image display device of the invention that comprises the optical film of the invention may be fabricated according to a process that includes heat treatment, and its image display quality is good.

### BRIEF DESCRIPTION OF THE DRAWINGS

FIG. 1 is an IR spectrum of a film P-1.

FIG. 2 is an IR spectrum of a film P-2.

### BEST MODE FOR CARRYING OUT THE INVENTION

The optical film of the invention, and the image display device of the invention that comprises the optical film are described in detail hereinunder. The description of the constitutive elements of the invention given hereinunder is for some typical embodiments of the invention, to which, however, the invention should not be limited. In this description, the numerical range expressed by the wording “a number to another number” means the range that falls between the former number indicating the lowermost limit of the range and the latter number indicating the uppermost limit thereof.

### [Polymer]

The optical film of the invention is characterized in that it contains a polymer having a recurring unit of the following formula (1) (hereinafter referred to as “polymer in the invention”). The polymer in the invention having a recurring unit of formula (1), and the polymer for use in the optical film of the invention are described below.

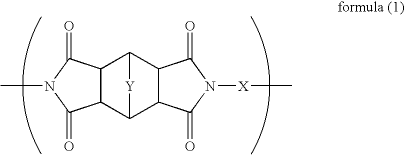

In formula (1), Y represents a methylene group, an ethylene group or an ethenylene group, preferably an ethylene group or an ethenylene group, more preferably an ethylene group.

In formula (1), X is represented by the following formula (2):

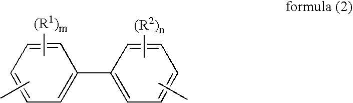

In formula (2), R¹ and R² each independently represent a halogen atom, a substituted or unsubstituted alkyl group, a substituted or unsubstituted alkoxy group, or a substituted or unsubstituted aryl group. Their examples are a halogen atom (e.g., a chlorine atom, a bromine atom, a fluorine atom or an iodine atom, preferably a fluorine atom, a chlorine atom or a bromine atom), a substituted or unsubstituted alkyl group (preferably having from 1 to 8 carbon atoms such as a methyl group, an ethyl group, a propyl group, an isopropyl group, a trifluoromethyl group, more preferably a methyl group, a trifluoromethyl group or an isopropyl group), a substituted or unsubstituted alkoxy group (preferably having from 1 to 8 carbon atoms such as an ethoxy group, a methoxy group, more preferably a phenoxy group or a methoxy group), or a substituted or unsubstituted aryl group (preferably a monocyclic or condensed polycyclic aromatic group having from 6 to 14 carbon atoms, such as a phenyl group, a naphthyl group, a p-methoxyphenyl group, more preferably a phenyl group). Preferably, R¹ and R² each are a halogen atom, or a substituted or unsubstituted alkyl group. The halogen atom is more preferably a fluorine atom or a chlorine atom; and the substituted or unsubstituted alkyl group is more preferably a methyl group, an ethyl group or a trifluoromethyl group.

In formula (2), m and n each independently indicate an integer of from 0 to 4, preferably an integer of from 1 to 4, more preferably an integer of 1 or 2, even more preferably 1. Preferably, R¹ and R² are in the ortho-position relative to the linking group that links the benzene rings.

The linking group to the nitrogen atom is preferably in the 3- or 4-position relative to the linking group that links the benzene rings, more preferably in the 4-position.

Preferably, the molar percentage, represented by i, of the recurring unit of formula (1) in the polymer in the invention falls within a range of 50≦i≦100 mol %, more preferably 60≦i≦100 mol %, even more preferably 80≦i≦100 mol %.

The polymer in the invention may have any other recurring unit than polyimide, and, for example, it may contain polyester, polyamide, polyamidic acid, etc.

The polyimide comprising a recurring unit of formula (1) (hereinafter referred to as “polyimide in the invention”) is described below, to which, however, the polymer usable in the invention should not be limited.

The polyimide in the invention may be produced, for example, by reacting a tetracarboxylic acid or its derivative and a diamine. Examples of the tetracarboxylic acid or its derivative are substituted or unsubstituted bicyclo[2.2.1]heptane-2,3,5,6-tetracarboxylic acid, bicyclo[2.2.2]octane-2,3,5,6-tetracarboxylic acid and bicyclic[2.2.2]oct-7-ene-2,3,5,6-tetracarboxylic acid, and their derivatives, acid anhydrides, acid chlorides and esters. Examples of the diamine are aromatic diamines (diaminobiphenyl derivatives) containing a linking group of formula (2).

Examples of the linking group of formula (2) (A-1 to A-13) are described below in the form of diamines corresponding to them, to which, however, the invention should not be limited.

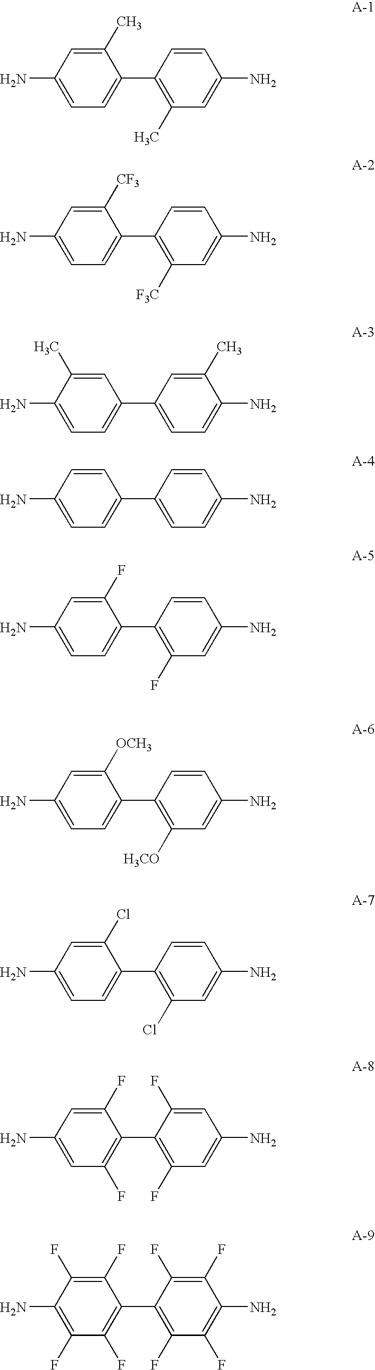

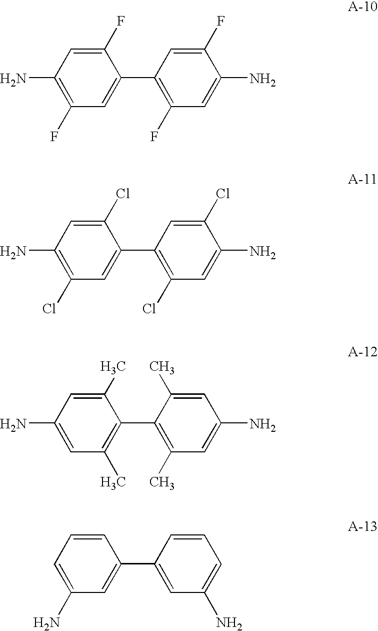

Of the examples of the linking group of formula (2), as mentioned above in the form of diamines corresponding to them, preferred are A-1, A-2, A-3, A-11 and A-12 from the viewpoint of the polymerization reactivity, the polyimide solubility and the stretchability; more preferred are A-1, A-2 and A-12; even more preferred is A-2.

The polyimide in the invention may be copolymerized with any other tetracarboxylic acid than substituted or unsubstituted bicyclo[2.2.1]heptane-2,3,5,6-tetracarboxylic acid, bicyclo[2.2.2]octane-2,3,5,6-tetracarboxylic acid and bicyclic[2.2.2]oct-7-ene-2,3,5,6-tetracarboxylic acid (these are hereinafter referred to as “other tetracarboxylic acids”), not detracting from the effect of the invention. When the polyimide is copolymerized with any other tetracarboxylic acid, then the molar percentage of the other tetracarboxylic acid in all the constitutive tetracarboxylic acids, as represented by x, preferably falls within a range of 0.01≦x≦70 mol %, more preferably 0.01≦x≦50 mol %, even more preferably 0.01≦x ≦30 mol %.

In addition, the polyimide in the invention may also be copolymerized with any other diamine than the aromatic diamine that contains the linking group of formula (2) (hereinafter these are referred to as “other diamines”), for the purpose of improving the properties thereof such as the heat resistance and the transparency thereof not detracting from the effect of the invention. When the polyimide is copolymerized with any other diamine, then the molar percentage of the other diamine in all the constitutive diamines, as represented by y, preferably falls within a range of 0.01≦y≦80 mol %, more preferably 0.01≦y≦70 mol %, even more preferably 0.01≦y ≦50 mol %.

Examples of the other tetracarboxylic acids are mentioned below in the form of carboxylic acid structures corresponding to them.

They are (trifluoromethyl)pyromellitic acid, di(trifluoromethyl)pyromellitic acid, diphenylpyromellitic acid, dimethylpyromellitic acid, bis[3,5-di(trifluoromethyl)phenoxy]pyromellitic acid, 2,3,3′,4′-biphenyltetracarboxylic acid, 3,3′,4,4′-biphenyltetracarboxylic acid, 3,3′,4,4′-tetracarboxydiphenyl ether, 2,3′,3,4′-tetracarboxydiphenyl ether, 3,3′,4,4′-benzophenonetetracarboxylic acid, 2,3,6,7-tetracarboxynaphthalene, 1,4,5,8-tetracarboxynaphthalene, 3,3′,4,4′-tetracarboxydiphenylmethane, 3,3′,4,4′-tetracarboxydiphenyl sulfone, 2,2-bis(3,4-dicarboxyphenyl)propane, 2,2-bis(3,4-dicarboxyphenyl)hexafluoropropane, 5,5′-bis(trifluoromethyl)-3,3′,4,4′-tetracarboxybiphenyl, 2,2′,5,5′-tetrakis(trifluoromethyl)-3,3′,4,4′-tetracarboxybiphenyl, 5,5′-bis(trifluoromethyl)-3,3′,4,4′-tetracarboxydiphenyl ether, 5,5′-bis(trifluoromethyl)-3,3′,4,4′-tetracarboxybenzophenone, bis[(trifluoromethyl)dicarboxyphenoxy]benzene, bis(dicarboxyphenoxy)bis(trifluoromethyl)benzene, bis(dicarboxyphenoxy)tetrakis(trifluoromethyl)benzene, 3,4,9,10-tetracarboxyperylene, 2,2-bis[4-(3,4-dicarboxyphenoxy)-phenyl]propane, cyclobutanetetracarboxylic acid, cyclopentanetetracarboxylic acid, 2,2-bis[4-(3,4-dicarboxy-phenoxy)phenyl]hexafluoropropane, bis(3,4-dicarboxyphenyl)-dimethylsilane, 1,3-bis(3,4-dicarboxyphenyl)tetramethyl-disiloxane, difluoropyromellitic acid, 1,4-bis(3,4-dicarboxytrifluorophenoxy)tetrafluorobenzene, 1,4-bis(3,4-dicarboxytrifluorophenoxy)octafluorobiphenyl, pyrazine-2,3,5,6-tetracarboxylic acid, pyrrolidine-2,3,4,5-tetra-carboxylic acid, thiophene-2,3,4,5-tetracarboxylic acid, 9,9-bis(3,4-dicarboxyphenyl)fluorene.

Examples of the other diamines are mentioned below.

They are p-phenylenediamine, m-phenylenediamine, o-phenylenediamine, 2,2-bis[4-(4-aminophenoxy)phenyl]-propane, 2,2-bis[4-(4-aminophenoxy)phenyl]hexafluoropropane, 4,4′-bis(4-aminophenoxy)biphenyl, bis[4-(4-aminophenoxy)-phenyl]sulfone, bis[4-(3-aminophenoxy)phenyl]sulfone, 4,4′-diaminodiphenyl ether, 3,4′-diaminodiphenyl ether, bis[4-(4-aminophenoxy)phenyl]ether, 1,4-bis(4-aminophenoxy)benzene, 1,3-bis(4-aminophenoxy)benzene, 2,2-bis(4-aminophenyl)propane, 2,2-bis(4-aminophenyl)hexafluoropropane, 4,4′-diaminobenzophenone.

For obtaining the polyimide from tetracarboxylic acid and diamine such as those mentioned above, there may be employed a one-stage polymerization method that comprises polymerizing a tetracarboxylic acid (especially a tetracarboxylic acid anhydride) and a diamine in an organic polar solvent at a high temperature to give a polyimide; and a two-stage polymerization method that comprises reacting a tetracarboxylic acid (especially a tetracarboxylic acid anhydride) and a diamine at a low temperature to give a polyamidic acid, then applying the acid onto a substrate to form a film thereon, and imidating it at a high temperature. The polymerization temperature in the one-stage polymerization method may be from 100 to 250° C., preferably from 150 to 200° C.; and the polymerization time may be from 0.5 to 20 hours, preferably from 1 to 15 hours. After the polymerization, the solution may be directly applied onto a substrate such as a glass plate or a metal plate and the solvent may be evaporated away to produce a polyimide film. If desired, the polymerization solution may be reprecipitated in a bad solvent such as methanol or water, then the solid precipitate may be dissolved in a good solvent, and the resulting solution may be applied onto a substrate such as a glass plate or a metal plate and the solvent may be evaporated away to produce a polyimide film. If the imidation is insufficient, then the film formed on the substrate may be heated at a temperature around the glass transition temperature of the polymer to attain the imidation, whereby the intended polyimide film may be obtained. In the two-stage polymerization method, the polyamidic acid production may be effected at a temperature of from 0 to 120° C., preferably from 15 to 120° C., more preferably from 20 to 110° C. for a period of time of from 0.5 to 100 hours, preferably from 1 to 70 hours, and after the polymerization, the resulting solution may be directly applied onto a substrate such as a glass plate or a metal plate and heated at 200° C. to 350° C. whereby the polymer may be imidated and the intended polyimide film may be thus produced.

Preferably, the polyimide of the invention is produced according to the above-mentioned one-stage polymerization method. Though depending on the type of the tetracarboxylic acid anhydride and the diamine used, the solute concentration in the polymerization reaction is preferably from 5 to 60% by mass, more preferably from 5 to 50% by mass, even more preferably from 10 to 40% by mass.

When a high-molecular polyimide could not be obtained even though the polymerization temperature, the polymerization time and the solute concentration are suitably controlled, then an additive may be added to the polymerization system. For the additive, employable are a catalyst (e.g., triethylamine, pyridine), an azeotropic agent (e.g., toluene, xylene), a condensing agent, a dehydrating agent (e.g., triphenyl phosphite, acetic anhydride). Preferably, the polyimide of the invention is produced by the use of additives of triphenyl phosphite and pyridine. In producing the polyimide and in increasing the molecular weight thereof, sublimation purification or recrystallization purification of the acid dianhydride and the diamine is necessary. However, when triphenyl phosphite and pyridine are used, then high-molecular polyimide can be obtained in a simplified manner even though unpurified monomers are used. Preferably, the additive concentration is from 0.5 to 70 mol % of the monomer concentration, more preferably from 1 to 50 mol %, even more preferably from 5 to 30 mol %.

The solvent (organic solvent) to be used when the polyimide in the invention is polymerized and applied onto a substrate may be any one capable of dissolving the diamine and the tetracarboxylic acid used and dissolving the polyamidic acid and the polyimide produced. Examples of the solvent are N,N-dimethylformamide, N,N-dimethylacetamide, N-methylpyrrolidone, dimethyl sulfoxide, p-chlorophenol, m-cresol. When the polyimide of the invention is soluble in a low-boiling point solvent such as acetone, 2-butanone, tetrahydrofuran, then the solvents may be used in film formation and will be effective for greatly reducing the production cost. One or more such solvents may be used either singly or as combined.

Especially preferably, the polyimide of the invention is produced in a process comprising a step of condensing a tetracarboxylic acid or its derivative and a diaminobiphenyl derivative in an organic polar solvent in the presence of triphenyl phosphite.

The organic polar solvent as referred to herein is meant to indicate an organic solvent capable of dissolving the diamine and the tetracarboxylic acid used and the polyamidic acid and the polyimide produced. Its preferred examples are N,N-dimethylformamide, N,N-dimethylacetamide, N-methylpyrrolidone, dimethyl sulfoxide, p-chlorophenol, m-cresol. Any other solvent than such an organic polar solvent, such as 2-butanone, 4-methyl-2-pentanone, butyl acetate, ethyl acetate, toluene or xylene, may also be used along with the organic polar solvent. The triphenyl phosphite concentration is preferably from 0.5 to 70 mol % of the monomer concentration, more preferably from 1 to 50 mol %, even more preferably from 5 to 30 mol %.

In producing polyimide and polyimide precursor (“polyimide precursor” is an organic compound capable of undergoing ring closure under heat or through chemical reaction to form an imide ring to thereby produce a polyimide), a dicarboxylic acid and a monoamine may be used along with the monomers for controlling the molecular weight of the polymer to be produced and for preventing the polymer from being colored. Preferably, a dicarboxylic acid for forming an imido bond is added to the polymerization system, more preferably a dicarboxylic acid anhydride thereto.

Regarding the molecular weight of the polyimide in the invention, the weight-average molecular weight thereof is preferably from 20,000 to 500,000, more preferably from 20,000 to 300,000, even more preferably from 30,000 to 200,000. When the polyimide has a molecular weight of at least 20,000, then it is favorable since the polymer may form a film and its film may have good mechanical properties. On the other hand, when the polyimide has a molecular weight of at most 500,000, then it is also favorable since the molecular weight of the polymer is easy to control in polymer production and the polymer solution may have a suitable viscosity. For the molecular weight of the polyimide of the invention, the viscosity of the polyimide solution or that of the polyimide precursor solution could be a criterion.

The viscosity of the solution thereof in producing the polyimide and polyimide precursor in the invention is preferably from 0.5 to 200 Pa·s, more preferably from 1,000 to 100,000 mPa·s, even more preferably from 2,000 to 60,000 mPa·s. When the polyimide or polyimide precursor in the invention is used as its solution, then its concentration is preferably at least 10% by mass, more preferably at least 20% by mass, even more preferably at least 30% by mass. When the concentration of the polyimide or polyimide precursor is at least 10% by mass, then the coating efficiency may be increased. The uppermost limit of the polyimide or polyimide precursor concentration is preferably at most 80% by mass from the viewpoint of sufficient dissolution of polyimide and polyimide precursor in a solvent, more preferably at most 70% by mass.

The heat-resistant temperature of the polyimide in the invention is preferably as high as possible, and the heat resistance of the polymer may be evaluated on the basis of the glass transition temperature (Tg) thereof measured through DSC, as the criterion for it. In this case, Tg of the polymer is preferably 350° C. or higher, more preferably 380° C. or higher, even more preferably 400° C. or higher. The uppermost limit of Tg is preferably as high as possible, but more preferably not higher than 700° C.

Preferred examples of the polyimide having a structure of formula (1) are mentioned below, to which, however, the invention should not be limited.

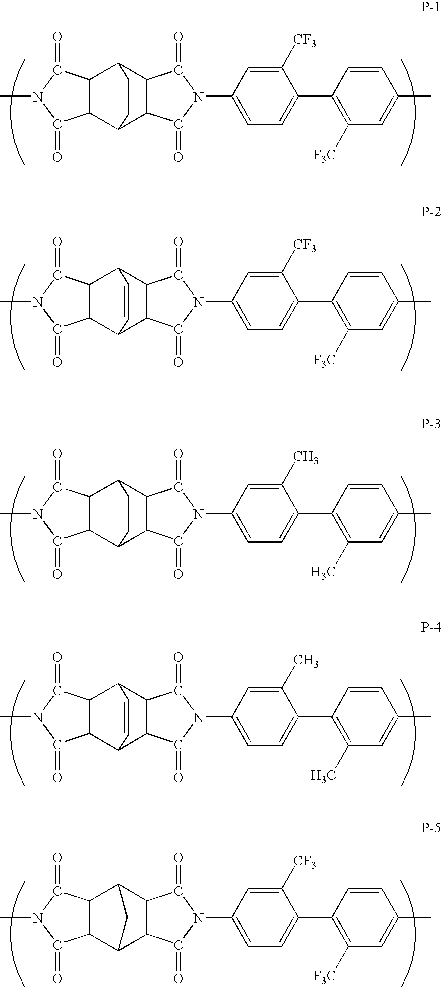

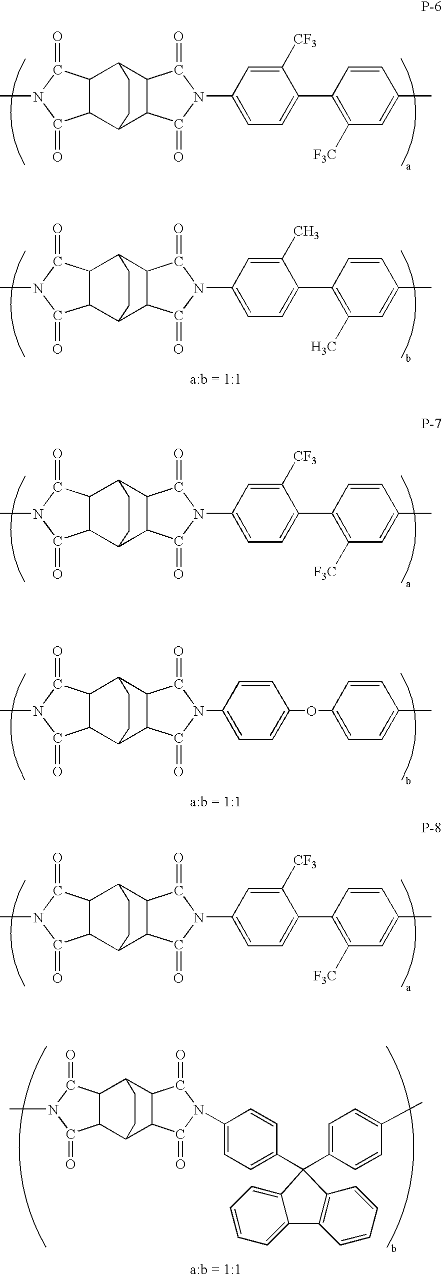

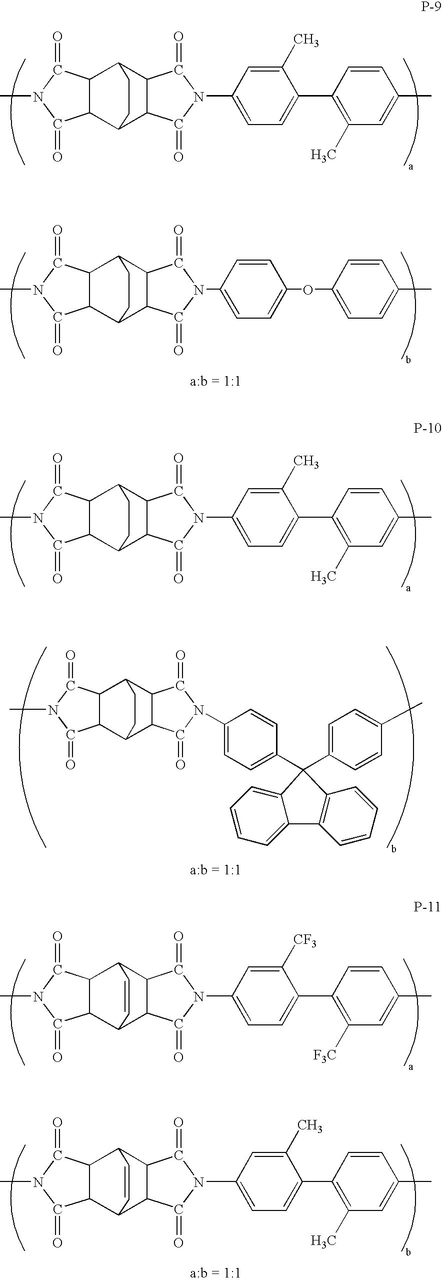

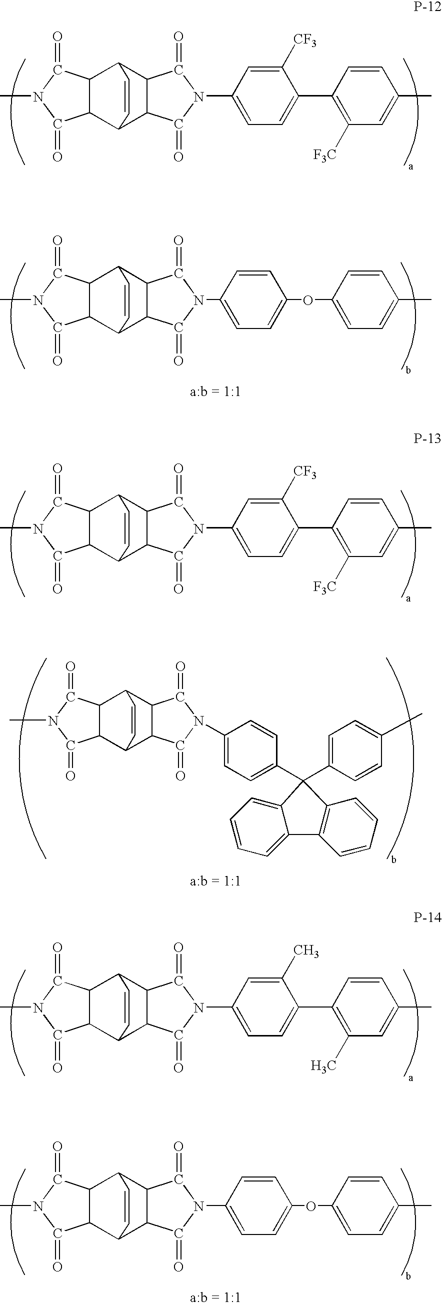

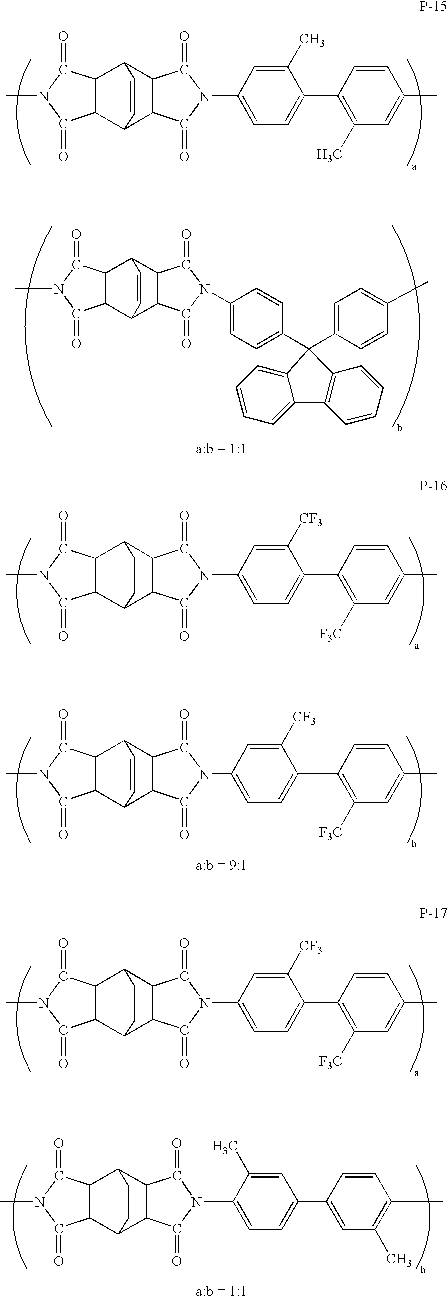

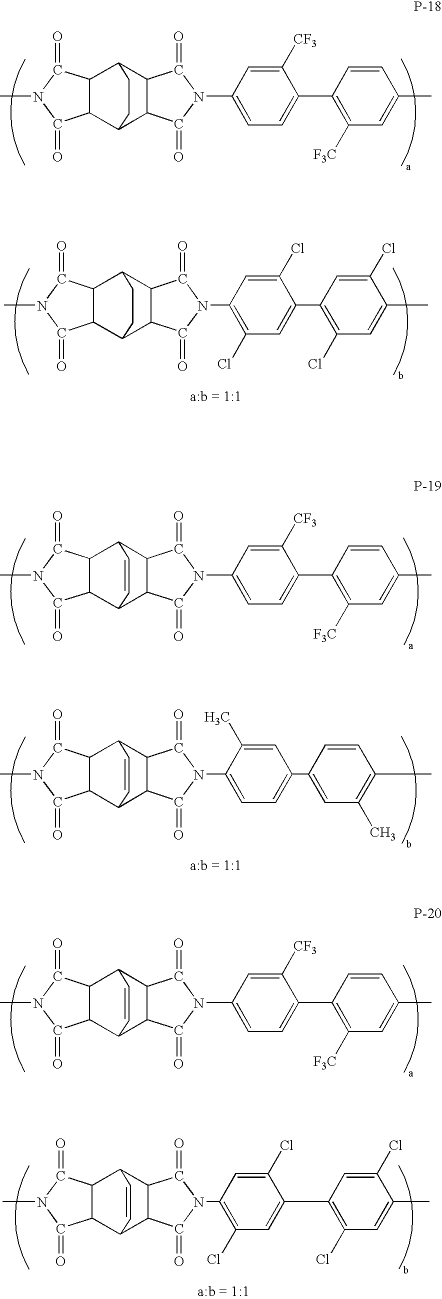

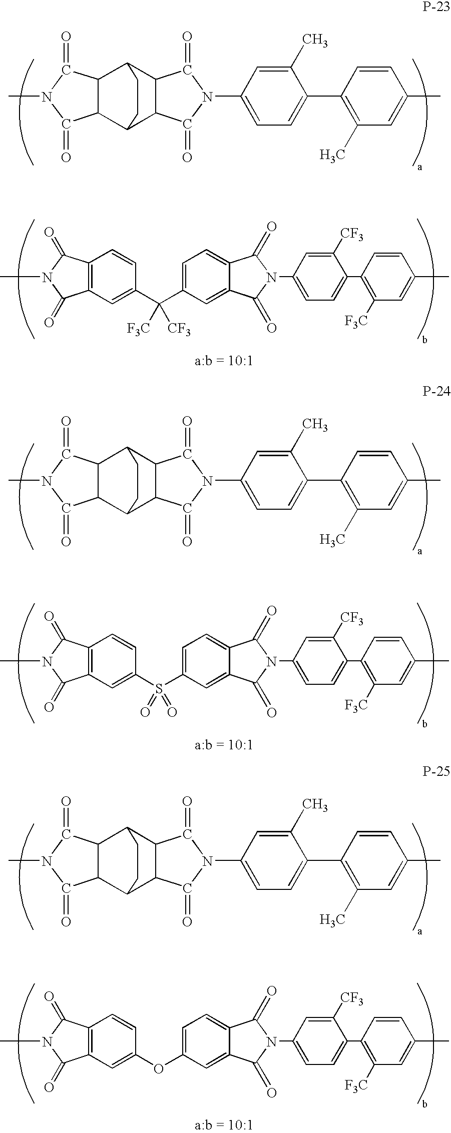

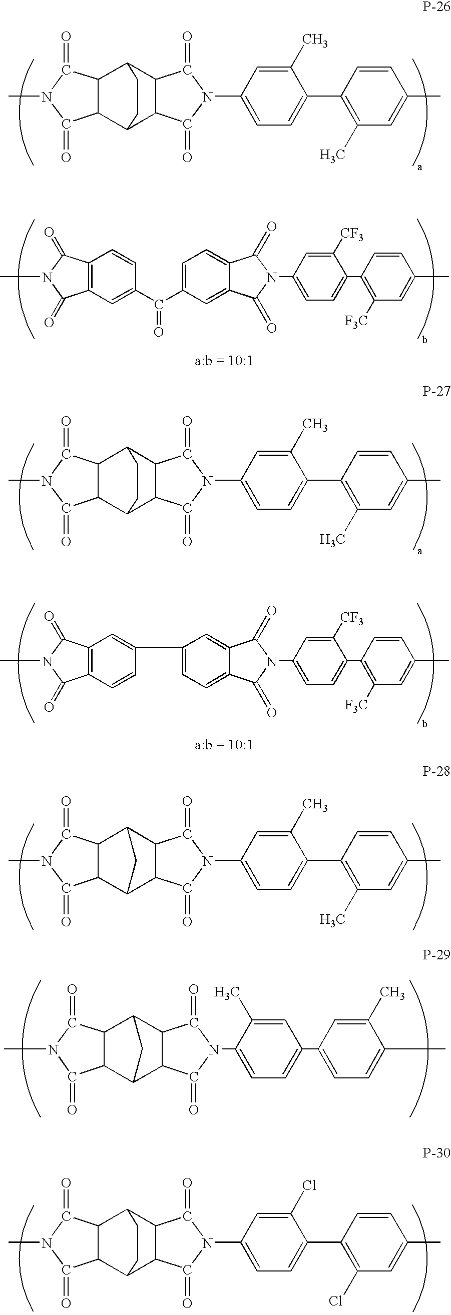

### [Optical Film]

The optical film comprising the polymer of the invention (optical film of the invention) is described below. The “optical film” as referred to herein means that the film has a thickness of from 10 μm to 700 μm and the light transmittance at a wavelength of 420 nm of the film having a thickness of 50 μm is at least 40%.

When a polyimide solution is used, the optical film of the invention may be obtained by applying the polyimide solution onto a substrate and peeling the resulting film from the substrate. When a polyimide precursor solution is used, then the optical film may be obtained as follows: The polyimide precursor solution is applied onto a substrate and heated thereon for imidation to form a polyimide coating film thereon, and the resulting polyimide coating film is peeled from the substrate to obtain the intended optical film of the invention. Concretely, a polyimide precursor solution is applied onto a substrate according to a known spin-coating method or spraying method, or by extruding it through a slit nozzle onto a substrate, or by applying it onto a substrate by the use of a bar coater, and then this is dried to remove the solvent in some degree, and when the coating film has been in a peelable condition, then it is peeled from the substrate and is further heated to give the optical film of the invention. Regarding the heating condition for the film peeled from the substrate, the highest temperature is preferably from 200 to 400° C., more preferably from 250 to 350° C. When the heating condition falls within the range of from 200 to 400° C., then it favorable since the imidation may smoothly go on and since the coating film is hardly deformed and deteriorated under heat.

Not specifically defined, the thickness of the optical film of the invention is preferably from 30 to 700 μm, more preferably from 40 to 200 μm, even more preferably from 50 to 150 μm. Also preferably, the haze value of the optical film of the invention is at most 3%, more preferably at most 2%, even more preferably at most 1%. Also preferably, the whole light transmittance of the film of the invention having a thickness of 50 μm is at least 70%, more preferably at least 80%, even more preferably at least 85%.

The “whole light transmittance of the film having a thickness of 50 μm” as referred to herein may be obtained as follows: The whole light transmittance of the film having a nonspecific thickness is measured, and from the value thus measured, the whole light transmittance of the film having a thickness of 50 μm is derived through calculative conversion.

The heat-resistant temperature of the optical film of the invention is preferably as high as possible, and the heat resistance of the film may be evaluated on the basis of the glass transition temperature (Tg) thereof measured through DSC, as the criterion for it. In this case, Tg of the film is preferably 350° C. or higher, more preferably 380° C. or higher, even more preferably 400° C. or higher.

When the optical film of the invention is formed of the polyimide of the invention alone according to a solution casting method, then there may be little difference between Tg of the polyimide used and Tg of the optical film formed so far as the film formed is sufficiently dried, and the difference therebetween could be within a range of measurement error.

The film of the invention may be stretched for the purpose of lowering its linear thermal expansion coefficient. For stretching it, employable is any known method. For example, the film may be stretched according to a roll-monoaxial stretching method, a tenter-monoaxial stretching method, a simultaneous biaxial stretching method, a successive biaxial stretching method or an inflation method, as in JP-A 62-115035, 4-152125, 4-284211, 4-298310, 11-48271.

Stretching the film may be attained at room temperature or under heat. The heating temperature is preferably not higher than the glass transition temperature of the film. The film may be stretched monoaxially or biaxially. The film may be stretched while it is dried, and this is especially effective when a solvent remains in the film.

When the film of the invention is stretched, it may be stretched while it still contains a solvent remaining therein for the purpose of lowering its apparent Tg. When Tg of the film is high, then the film may pyrolyze in thermal stretching; but when the film contains a solvent remaining therein, then it may be stretched at a temperature lower than its thermal decomposition temperature. The amount of the solvent to remain in the film is preferably from 0.1 to 70% by mass, more preferably from 1 to 50% by mass, even more preferably from 3 to 30% by mass. The temperature at which the film with a solvent remaining therein is stretched is preferably from 100 to 300° C., more preferably from 125 to 300° C., even more preferably from 150 to 250° C. For making the film contain a solvent therein, herein employable are a method of utilizing a wet film being dried and a method of adding a solvent to a dried film. In the invention, the former is preferred. The solvent to remain in the film may be any good solvent for the film, but is preferably a solvent of the same type as that used in doping. Regarding the condition under which the solvent-containing film is stretched, referred to is the same as that for the stretching methods mentioned hereinabove.

After stretched, the film of the invention may be subjected to heat treatment for removing the residual stress.

Preferably, the linear thermal expansion coefficient of the film of the invention is from −20 to 50 ppm/° C. within a temperature range of from 100° C. to (Tg−20)° C., more preferably from −10 to 50 ppm/° C., even more preferably from −10 to 40 ppm/° C. The film of the invention having a linear thermal expansion coefficient of from −20 to 50 ppm/° C. may prevent the defects of an inorganic material layer that may occur in lamination of the inorganic material layer on the film owing to the thermal expansion difference between the two.

Depending on its use, the optical film of the invention may be coated with any other layer, or the film substrate may be subjected to surface treatment of saponification, corona treatment, flame treatment, glow discharge treatment or the like for the purpose of increasing its adhesiveness to other parts. In addition, an adhesive layer and an anchor layer may be disposed on the film surface. Other various known functional layers may be imparted to the film depending on their use, for example, a smoothing layer for smoothing the film surface; a hard coat layer for improving the scratch resistance of the film surface; an UV-absorbent layer for enhancing the light fastness of the film; and a surface-roughened layer for improving the film conveyance.

### (Transparent Conductive Layer)

A transparent conductive layer may be provided on at least one surface of the optical film of the invention. The transparent conductive layer may be any known metal film or metal oxide film. Above all, preferred is a metal oxide film in view of its transparency, conductivity and mechanical properties. For it, for example, employable are metal oxide films of indium oxide, cadmium oxide or tin oxide with an impurity of tin, tellurium, cadmium, molybdenum, tungsten, fluorine, zinc and germanium added thereto; and metal oxide films of zinc oxide or titanium oxide with an impurity of aluminium added thereto. Above all, preferred is a thin film of indium oxide containing from 2 to 15% by mass of tin oxide or zinc oxide, as it has good transparency and good conductivity.

For forming the transparent conductive layer, any method is employable so far as it may give the intended thin film. For example, however, suitable for the film formation is a vapor-phase deposition method of depositing a material in a vapor phase, for example, a sputtering method, a vacuum vapor deposition method, an ion-plating method or a plasma CVD method. The film may be formed, for example, according to the methods described in Japanese Patent No. 3,400,324, or JP-A2002-322561 or 2002-361774. Above all, especially preferred is a sputtering method as the film formed may have especially excellent conductivity and transparency.

In the sputtering method, the vacuum vapor deposition method, the ion-plating method and the plasma CVD method, the vacuum degree is preferably from 0.133 mPa to 6.65 Pa, more preferably from 0.665 mPa to 1.33 Pa. Before forming the transparent conductive layer thereon, it is desirable that the optical film of the invention is subjected to surface treatment such as plasma treatment (back-sputtering) or corona treatment.

During the formation of the transparent conductive layer thereon, the optical film of the invention may be heated at 50 to 300° C.

The thickness of the transparent conductive layer that may be formed on the optical film of the invention is preferably from 20 to 500 nm, more preferably from 50 to 300 nm.

The surface resistivity of the transparent conductive layer that may be formed on the optical film of the invention, as measured at 25° C. and at a relative humidity of 60%, is preferably from 0.1 to 200 Ω/square, more preferably from 0.1 to 100 Ω/square, even more preferably from 0.5 to 60 Ω/square. Also preferably, the light transmittance of the transparent conductive layer on the optical film of the invention is at least 80%, more preferably at least 83%, even more preferably at least 85%.

### (Gas-Barrier Layer)

Preferably, a gas-barrier layer is formed on at least one surface of the optical film of the invention for retarding the gas penetration through the film. For the gas-barrier layer, for example, preferably mentioned are metal oxides comprising, as the essential ingredient thereof, one or more metal selected from a group consisting of silicon, aluminium, magnesium, zinc, zirconium, titanium, yttrium and tantalum; metal nitrides with silicon, aluminium or boron; and their mixtures. Of those, more preferred are metal oxides comprising, as the essential ingredient thereof, a silicon oxide having a ratio of the number of oxygen atom to that of silicon atom of from 1.5 to 2.0, in view of their gas-barrier property, transparency, surface smoothness, flexibility, film stress and cost. The inorganic gas-barrier layer may be formed, for example, according to a vapor-phase deposition method of depositing a material in a vapor phase, for example, a sputtering method, a vacuum vapor deposition method, an ion-plating method or a plasma CVD method. Above all, especially preferred is a sputtering method as the layer formed may have an especially excellent gas-barrier property. During the formation of the gas-barrier layer thereon, the optical film of the invention may be heated at 50 to 200° C.

The thickness of the inorganic gas-barrier layer that may be formed on the optical film of the invention is preferably from 10 to 300 nm, more preferably from 30 to 200 nm.

The gas-barrier layer may be formed on the same side as or on the opposite side to the transparent conductive layer formed on the optical film of the invention, but is preferably formed on the opposite side to the transparent conductive layer.

Regarding the gas-barrier property of the optical film of the invention with the gas-barrier layer formed thereon, the water vapor permeability through the film, as measured at 40° C. and at a relative humidity of 90%, is preferably at most 5 g/m²·day, more preferably at most 1 g/m²·day, even more preferably at most 0.5 g/m²·day. The oxygen permeability through the film, as measured at 40° C. and at a relative humidity of 90%, is preferably at most 1 ml/m²·day·atm (1×10⁵ ml/m²·day·Pa), more preferably at most 0.7 ml/m²·day·atm (7×10⁴ ml/m²·day·Pa), even more preferably at most 0.5 ml/m²·day·atm (5×10⁴ ml/m²·day·Pa).

### (Defect Compensation Layer)

For further improving the barrier property thereof, the optical film of the invention preferably has a defect compensation layer formed adjacent to the gas-barrier layer thereof. The defect compensation layer may be formed according to (1) a method of utilizing an inorganic oxide layer formed through sol-gel reaction as in U.S. Pat. No. 6,171,663 or JP-A2003-94572; or (2) a method of utilizing an organic substance layer as in U.S. Pat. No. 6,413,645. As described in these references, it is desirable that the defect compensation layer is formed according to a method of vapor deposition in vacuum followed by curing with UV rays or electron rays, or a method of coating followed by heating and curing through exposure to electron rays or UV rays. In the latter case of forming the defect compensation layer in a coating mode, employable are various known coating methods of, for example, spraying, spin coating or bar coating.

### [Image Display Device]

The optical film of the invention may be used as a substrate for thin-film transistor (TFT) display devices. For fabricating TFT arrays, for example, referred to is the method described in JP-T 10-512104. The substrate may have a color filter for color image display. The color filter may be fabricated in any method, but is preferably fabricated through photolithography.

Optionally coated with various functional layers formed thereon, the optical film of the invention may be used in image display devices. The image display devices as referred to herein are not specifically defined and may be any conventional ones. Using the optical film of the invention gives flat panel displays of good display quality. The flat panel displays include liquid-crystal displays, plasma displays, electroluminescent (EL) displays, fluorescent character display tubes, light-emitting diodes. In addition to these, the optical film of the invention is also usable in other display devices heretofore having a glass substrate, as a substrate substitutive for the glass substrate in those conventional display systems. Further, the optical film of the invention is usable in other applications of solar cells and touch panels. Regarding the touch panels, the invention is applicable to those described in JP-A 5-127822 and 2002-48913.

When the optical film of the invention is used in liquid-crystal displays, it is desirable that the polyimide constituting the optical film of the invention is an amorphous polymer in order to attain the optical uniformity of the film. In addition, the birefringence of the optical film of the invention is preferably as small as possible, and in particular, the in-plane retardation (Re) of the film is preferably at most 50 nm, more preferably at most 30 nm, even more preferably at most 15 nm.

The optical film of the invention is favorable for use in liquid-crystal display devices. Liquid-crystal display devices are grouped into two, reflection-type liquid-crystal display devices and transmission-type liquid-crystal display devices.

The reflection-type liquid-crystal display device comprises a lower substrate, a reflective electrode, a lower alignment film, a liquid-crystal layer, an upper alignment film, a transparent electrode, an upper substrate, a λ/4 plate and a polarizing film laminated in that order from the bottom. In this, the optical film of the invention may be used as the λ/4 plate by controlling the optical properties thereof, or as the protective film for the polarizing film, but is preferably used as the substrate (upper and lower substrates) in view of its heat resistance and also as the transparent electrode and the upper substrate on the alignment film in view of its transparency. If desired, a gas-barrier layer and TFT may be provided in the reflection-type liquid-crystal display device. For color image display, it is desirable that a color filter layer is disposed between the reflective electrode and the lower alignment film, or between the upper alignment film and the transparent electrode.

The transmission-type liquid-crystal display device comprises a backlight, a polarizer, a λ/4 plate, a lower transparent electrode, a lower alignment film, a liquid-crystal layer, an upper alignment film, an upper transparent electrode, an upper substrate, a λ/4 plate and a polarizing film disposed in that order from the bottom. In this, the optical film of the invention may be used as the λ/4 plate by controlling the optical properties thereof, or as the protective film for the polarizing film, but is preferably used as the substrate (upper and lower substrates) in view of its heat resistance and also as the transparent electrode and the upper substrate on the alignment film. If desired, a gas-barrier layer and TFT may be provided in the transmission-type liquid-crystal display device. For color image display, it is desirable that a color filter layer is disposed between the lower transparent electrode and the lower alignment film, or between the upper alignment film and the transparent electrode.

Various display modes are proposed for the structure of the liquid-crystal layer (liquid-crystal cell), including, for example, TN (twisted nematic), IPS (in-plane switching), FLC (ferroelectric liquid crystal), AFLC (antiferroelectric liquid crystal), OCB (optically compensatory bent), STN (supper twisted nematic), VA (vertically aligned) and HAN (hybrid aligned nematic) modes. In addition, a modified display mode is also proposed, in which any of the above-mentioned display modes are aligned and divided. The optical film of the invention is effective in liquid-crystal display devices of any display modes as above. In addition, the film is also effective in liquid-crystal display devices of any types of transmission or reflection, and further in semitransmission-type liquid-crystal display devices.

These liquid-crystal display devices are described in JP-A 2-176625; JP-B 7-69536; MVA (SID97, Digest of Tech. Papers (preprint) 28 (1997) 854); SID99, Digest of Tech. Papers (preprint) 30 (1999) 206; JP-A 11-258605; Survival (Monthly Display, Vol. 6, No. 3 (1994) 14); PVA (Asia Display 98, Proc. of the-18th-Inter. Display Res. Conf. (preprint) (1998) 383); Para-A (LCD/PDP International '99); DDVA (SID98, Digest of Tech. Papers (preprint) 29 (1998) 838); EOC(SID98, Digest of Tech. Papers (preprint) 29 (1998) 319); PSHA (SID98, Digest of Tech. Papers (preprint) 29 (1998) 1081); RFFMH (Asia Display 98, Proc. of the-18th-Inter. Display Res. Conf. (preprint) (1998) 375); HMD (SID98, Digest of Tech. Papers (preprint) 29 (1998) 702); JP-A 10-123478; International Laid-Open WO98/48320; Japanese Patent No. 3,022,477; and International Laid-Open WO00/65384.

If desired, a gas-barrier layer and TFT may be formed on the optical film of the invention, and the film may be used in an organic EL device as a substrate with a transparent electrode formed thereon.

Examples of the layer constitution of an organic EL device are anode/light-emitting layer/transparent cathode; anode/light-emitting layer/electron-transporting layer/transparent cathode; anode/hole-transporting layer/light-emitting layer/electron-transporting layer/transparent cathode; anode/hole-transporting layer/light-emitting layer/transparent cathode; anode/light-emitting layer/electron-transporting layer/electron-injection layer/transparent cathode; anode/hole-injection layer/hole-transporting layer/light-emitting layer/electron-transporting layer/electron-injection layer/transparent cathode.

The organic EL device in which the optical film of the invention can be used may attain light emission when a direct current (optionally including an alternating current component) voltage (generally from 2 V to 40 V) or a direct current is applied to between the anode and the cathode.

For driving the light-emitting devices mentioned above, for example, referred to are the methods described in Japanese Patent No. 2,784,615; JP-A 2-148687, 6-301355, 5-29080, 7-134558, 8-234685, 8-241047; U.S. Pat. Nos. 5,828,429, 6,023,308.

The invention is described in more detail with reference to the following Examples, in which the material used, its amount and the ratio, the details of the treatment and the treatment process may be suitably modified or changed not overstepping the sprit and the scope of the invention. Accordingly, the invention should not be limitatively interpreted by the Examples mentioned below.

### EXAMPLE 1

### 1. Production of Films

### (1) Production of Film P-1:

32 g of 2,2′-bis(trifluoromethyl)-4,4′-diaminobiphenyl was put into a reactor equipped with a thermometer, a stirrer and a nitrogen-introducing duct, and this was dissolved in 230 g of N-methyl-2-pyrrolidone. Then, 25 g of bicyclo[2.2.2]octane-2,3,5,6-tetracarboxylic acid was gradually added to it at 15° C. This was reacted at 30° C. for 1 hour, then at 70° C. for 1 hour and further at 100° C. for 1 hour, and this gave a transparent solution. Next, as additives, 6.2 g of triphenyl phosphite and 16 g of pyridine were gradually and dropwise added to it, and this was stirred at 100° C. for 0.5 hours, then at 130° C. for 0.5 hours, at 150° C. for 0.5 hours and at 170° C. for 5 hours. Next, the solution was kept cooled, and then reprecipitated in a mixed solution of 2 liters of methanol and 2 liters of water to obtain a polymer. This was filtered, the deposit was dried and again dissolved in N,N-dimethylacetamide. Using a film applicator, the resulting solution was cast on a glass plate, and dried thereon in a nitrogen atmosphere at 80° C. for 2 hours and then at 150° C. for 1 hour, and thereafter further dried under heat at 200° C. for 1 hour, then at 250° C. for 1 hour and at 300° C. for 1 hour, and a film P-1 was thus obtained.

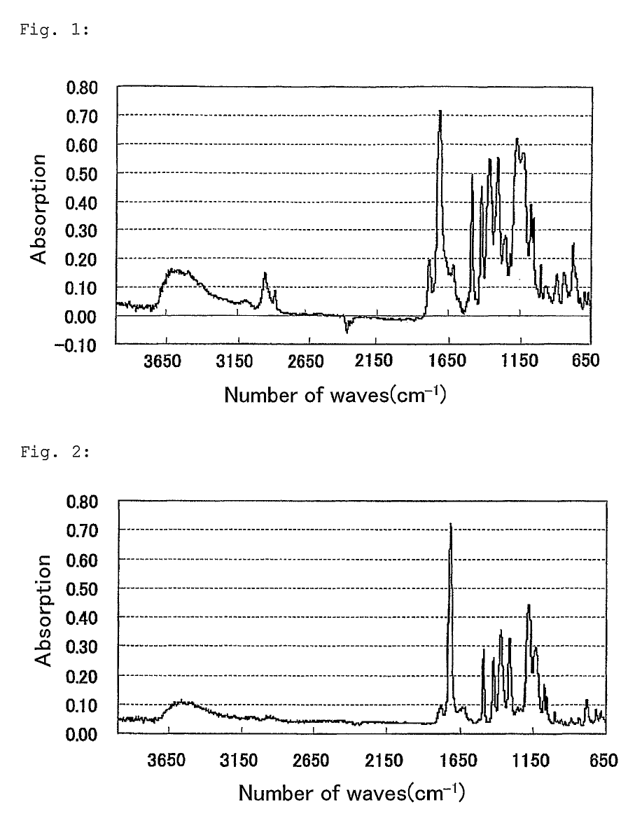

FIG. 1 shows the IR spectrum of the film P-1. This gives a peak between a wavelength of 1720 cm⁻¹ and a wavelength of 1780 cm⁻¹, confirming that the film P-1 is a polyimide film.

In the above process, triphenyl phosphite and pyridine were added to the monomer in an amount of 20 mol % of the monomer. For confirming the effect of the additives, a reaction system in which the amount of the additives differs from the above, a reaction system which contains only triphenyl phosphite, a reaction system which contains only pyridine, and a reaction system which contains no additive were prepared in the same manner as above, and the molecular weight of the polymers obtained was measured.

### <Weight-Average Molecular Weight>

Using Tosoh's HLC-8120 GPC for polystyrene-based GPC with a solvent of tetrahydrofuran or DMF, the weight-average molecular weight of the polymer is determined, relative to that of a molecular weight-standardized polystyrene.

TABLE 1

| | | | | Comparative | Comparative |
|---|---|---|---|---|---|
| | the Invention | the Invention | the Invention | Example | Example |
| Additive | triphenyl | triphenyl | triphenyl | pyridine | no |
| | phosphite/pyridine | phosphite/pyridine | phosphite | | |
| Amount of Additive (mol %) | 5 | 20 | 20 | 20 | 0 |
| Weight-Average Molecular Weight | 70000 | 150000 | 100000 | 29000 | 15000 |

From Table 1, it is understood that addition of triphenyl phosphite is effective for obtaining a polymer having a high molecular weight. It is also understood that additionally using pyridine is more desirable.

### (2) Production of Film P-2:

In the same manner as that for the film P-1, a film P-2 was produced from the compounds described in Table 2 below.

FIG. 2 shows the IR spectrum of the film P-2. This gives a peak between a wavelength of 1720 cm⁻¹ and a wavelength of 1780 cm⁻¹, confirming that the film P-2 is a polyimide film.

### (3) Production of Film of Comparative Example 1:

According to Example 1 in JP-A 9-95533, a compound of Comparative Example 1 was produced. A film formed of the compound is P-21.

### (4) Production of Film of Comparative Example 2:

According to Example in JP-A 2003-168800, a compound of Comparative Example 2 was produced. A film formed of the compound is P-22.

### 2. Determination of Characteristic Values

### (1) Determination of Glass Transition Temperature (Tg):

Using a differential scanning calorimeter (Seiko's DSC 6200), Tg of each optical film sample is determined in nitrogen at a heating speed of 10° C./min. The data are given in Table 2.

### (2) Determination of Linear Thermal Expansion Coefficient:

A film sample (19 mm×5 mm) is prepared, and this is analyzed through TMA (using Rigaku Denki's TMA 8310). The heating speed is 3° C./min. Three samples are tried in one test, and their data are averaged. The temperature range for calculation of linear thermal expansion coefficient is from 100° C. to (Tg−20)° C.

### (3) Transparency:

The optical film samples are visually checked for the transparency thereof. Those with no color are good, and those with color are not good. The results are given in Table 2.

TABLE 2

| | the Invention | the Invention | Comparative Example | Comparative Example |
|---|---|---|---|---|
| Polymer | P-1 | P-2 | P-21 | P-22 |
| Acid Dianhydride | bicyclo[2.2.2]octane- | bicyclo[2.2.2]oct-7-ene- | bicyclo[2.2.2]octane- | 1,2,4,5-cyclohexane- |
| | 2,3,5,6-tetracarboxylic acid | 2,3,5,6-tetracarboxylic acid | 2,3,5,6-tetracarboxylic acid | tetracarboxylic acid |
| Diamine | 2,2′-bis(trifluoromethyl)- | 2,2′-bis(trifluoromethyl)- | 4,4′-diaminodiphenyl ether | 4,4′-diaminodiphenyl ether |
| | 4,4′-diaminobiphenyl | 4,4′-diaminobiphenyl | | |
| Tg (° C.) | 383 | 388 | 385 | 315 |
| Linear Thermal | 43 | 42 | 53 | 69 |
| Expansion | | | | |
| Coefficient (ppm/° C.) | | | | |
| Transparency | good | good | good | good |

As is obvious from Table 2, it is understood that the films P-1 and P-2 are on the same level as that of the films P-21 and P-22 in point of the transparency thereof, but the former are better than the latter in point of the thermal expansiveness thereof. The polymer of the invention has low thermal expansiveness, good heat resistance and good optical properties.

### EXAMPLE 2

### Production of Stretched Films

### 1. Monoaxial Stretching

For confirming the fact that the stretched polymer of the invention shows extremely lowered thermal expansiveness, the polymer of the invention was stretched.

### <Stretching Treatment>

A film sample (2.0 cm×7.0 cm piece) is prepared, and monoaxially stretched at a pulling rate of 200 mm/min, using a tensilon (Orientec's Tensilon RTC-1210A). Three samples are tried in one test, and their data are averaged. (The chuck-to-chuck distance is 5 cm, and the draw ratio is 1.3 times.)

The polymer P-1 was dissolved in N,N-dimethylacetamide in a ratio of 20% by mass to prepare a dope. This was cast on a glass plate, using a doctor blade, and dried at 80° C. Before completely dried, this was peeled from the glass plate, cut into a piece having a size of 20 mm×70 mm, and stretched with a tensilon. The stretching condition was as follows: The resin temperature was 250° C., the pulling rate was 200 mm/min, the chuck-to-chuck distance was 50 mm, and the draw ratio was 1.3 times. After stretched, the film was dried in vacuum at 200° C. for 2 hours, and a monoaxially-stretched film was thus produced. The linear thermal expansion coefficient data of both the unstretched film and the stretched film are shown in Table 3 (the stretched film was measured in the stretching direction thereof). The polymers P-2, P-21 and P-22 were analyzed in the same manner as above.

TABLE 3

| | the Invention | the Invention | Comparative Example | Comparative Example |
|---|---|---|---|---|
| Polymer | P-1 | P-2 | P-21 | P-22 |
| Acid Dianhydride | bicyclo[2.2.2]octane- | bicyclo[2.2.2]oct-7-ene- | bicyclo[2.2.2]octane- | 1,2,4,5-cyclohexane- |
| | 2,3,5,6-tetracarboxylic | 2,3,5,6-tetracarboxylic acid | 2,3,5,6-tetracarboxylic acid | tetracarboxylic acid |
| | acid | | | |
| Diamine | 2,2′-bis(trifluoromethyl)- | 2,2′-bis(trifluoromethyl)- | 4,4′-diaminodiphenyl ether | 4,4′-diaminodiphenyl |
| | 4,4′-diaminobiphenyl | 4,4′-diaminobiphenyl | | ether |
| Linear Thermal Expansion | 43 | 42 | 53 | 69 |
| Coefficient before monoaxial | | | | |
| stretching (ppm/° C.) | | | | |
| Linear Thermal Expansion | 14 | 8 | 40 | 60 |
| Coefficient after monoaxial | | | | |
| stretching (ppm/° C.) | | | | |

From Table 3, it is understood that the linear expansion coefficient of the polyimide of the invention greatly lowers after stretching treatment.

### 2. Biaxial Stretching

The polymer P-1 was dissolved in N,N-dimethylacetamide in a ratio of 20% by mass to prepare a dope. This was cast on a glass plate, using a doctor blade, and dried at 80° C. Before completely dried, this was peeled from the glass plate, cut into a piece having a size of 120 mm×120 mm, and stretched with a simultaneous biaxial stretcher. The stretching condition was as follows: The resin temperature was 120° C., the pulling rate was 200 mm/min (both in the machine direction and in the cross direction), the chuck-to-chuck distance was 100 mm, and the draw ratio was 1.7 times (as a real ratio). The stretched film was stretched on a frame, dried in vacuum at 200° C. for 2 hours, then released from the frame, and heated at 300° C. for 2 hours. The linear thermal expansion coefficient data of the unstretched film, the monoaxially-stretched film and the biaxially-stretched film are shown in Table 4. The polymer P-2 was analyzed in the same manner as above.

TABLE 4

| | the Invention | the Invention |
|---|---|---|
| Polymer | P-1 | P-2 |
| Acid Dianhydride | bicyclo[2.2.2]octane- | bicyclo[2.2.2]oct-7-ene- |
| | 2,3,5,6-tetracarboxylic acid | 2,3,5,6-tetracarboxylic acid |
| Diamine | 2,2′-bis(trifluoromethyl)- | 2,2′-bis(trifluoromethyl)- |
| | 4,4′-diaminobiphenyl | 4,4′-diaminobiphenyl |
| Linear Thermal Expansion | 43 | 42 |
| Coefficient before monoaxial | | |
| stretching (ppm/° C.) | | |
| Linear Thermal Expansion | 14 | 8 |
| Coefficient after monoaxial | | |
| stretching (ppm/° C.) | | |
| Linear Thermal Expansion | 21 | 15 |
| Coefficient after biaxial | | |
| stretching (ppm/° C.) | | |

From Table 4, it is understood that the polyimide of the invention is biaxially stretchable, and stretching the polymer film is effective for reducing the linear thermal expansion coefficient both in the machine direction and in the cross direction thereof.

### EXAMPLE 3

### Formation of Gas-Barrier Layer and Transparent Electrode Layer

### 1. Formation of Gas-Barrier Layer

A target of Si was sputtered onto both surfaces of the optical film samples P-1, P-2, P-21 and P-22 fabricated in the above, according to a DC magnetron sputtering process under a vacuum of 500 Pa in an Ar atmosphere with oxygen being introduced into the chamber. The pressure was 0.1 Pa and the output power was 5 kW. A gas-barrier layer was thus formed, and it had a thickness of 60 nm. The water vapor permeation through the optical film samples with a gas-barrier layer formed on both surfaces thereof was at most 0.1 g/m²·day, measured at 40° C. and at a relative humidity of 90%; and the oxygen permeation through them was at most 0.1 ml/m² ·day, measured at 40° C. and at a relative humidity of 90%.

### 2. Formation of Transparent Conductive Layer

While the gas-barrier layer-coated optical film samples were heated at 300° C., a target of ITO (In₂O₃, 95 mas. %; SnO₂, 5 mas. %) was sputtered onto them according to a DC magnetron sputtering process under a vacuum of 0.665 Pa in an Ar atmosphere at an output power of 5 kW to thereby form a transparent conductive layer of an ITO film having a thickness of 140 nm on one surface of each sample. The surface resistivity of the transparent conductive layer-coated optical film samples was from 5 to 10 Ω/square.

3. Heat Treatment of Optical Film with Transparent Conductive Layer Formed Thereon

Assuming the disposition of TFT thereon, the optical film samples with a transparent conductive layer formed thereon were subjected to a heat cycle of heating them from 50° C. up to 350° C. at a heating rate of 5° C./min, then keeping them at 350° C. for 30 minutes, and thereafter cooling them from 350° C. to 50° C. at a cooling rate of 5° C./min. The heat cycle was repeated three times for all the samples, and the whole light transmittance and the surface resistivity of the samples were determined. The data are given in Table 5 below.

In Example 3, the transparent conductive layer-coated optical films were evaluated as follows:

### <Whole Light Transmittance>

According to JIS K7105, the whole light transmittance of each sample is measured with a haze meter (Nippon Denshoku's Z-Σ80).

### <Specific Resistivity of Conductive Layer>

According to JIS K7194, the surface resistivity of each sample is determined in a 4-terminal method. Mitsubishi Yuka's Lotest AMCP-T400 is used for the measurement. The samples having a surface resistivity of smaller than 10 mΩ·cm are good; and those having a surface resistivity of 10 mΩ·cm or more are not good.

TABLE 5

| | the Invention | the Invention | Comparative Example | Comparative Example |
|---|---|---|---|---|
| Polymer | P-1 | P-2 | P-21 | P-22 |
| Acid Dianhydride | bicyclo[2.2.2]octane- | bicyclo[2.2.2]oct-7-ene- | bicyclo[2.2.2]octane- | 1,2,4,5-cyclohexane- |
| | 2,3,5,6-tetracarboxylic acid | 2,3,5,6-tetracarboxylic acid | 2,3,5,6-tetracarboxylic acid | tetracarboxylic acid |
| Diamine | 2,2′-bis(trifluoromethyl)- | 2,2′-bis(trifluoromethyl)- | 4,4′-diaminodiphenyl ether | 4,4′-diaminodiphenyl ether |
| | 4,4′-diaminobiphenyl | 4,4′-diaminobiphenyl | | |
| Film Thickness (μm) | 100 | 100 | 100 | 100 |
| Gas-Barrier Layer | 60 | 60 | 60 | 60 |
| Thickness (nm) | | | | |
| Conductive Layer | 140 | 140 | 140 | 140 |
| Thickness (nm) | | | | |
| Whole Light | 81 | 90 | 80 | 82 |
| Transmittance (%) | | | | |
| Substrate Temperature | 300 | 300 | 300 | 300 |
| in forming Conductive | | | | |
| Layer (° C.) | | | | |
| Specific Resistivity of | good | good | not good | not good |
| Conductive Layer | | | | |

From Table 5, it is understood that the surface resistivity (specific resistivity of the conductive layer) of the transparent conductive layer-coated optical films formed from the films P-1 and P-2 was low, but the surface resistivity of the transparent conductive layer-coated optical films formed from the films P-21 and P-22 was high.

### EXAMPLE 4

### Fabrication of Organic EL Device Samples F-1 and F-2

In consideration of the data in Example 3, the transparent conductive layer-coated optical films having a low surface resistivity that had been formed from the films P-1 and P-2 were used for fabricating organic EL devices.

An aluminium lead wire was fitted to the transparent electrode layer of each transparent conductive layer-coated optical film, on which a transparent conductive layer had been formed and which had been subjected to heat treatment in Example 3, and it was worked into a laminate structure. The optical film samples with a transparent conductive layer formed thereon (transparent conductive layer-coated optical films) that had been formed from the films P-1 and P-2 were deformed a little but not remarkably.

An aqueous dispersion of polyethylenedioxythiophene/polystyrenesulfonic acid (Bayer's Baytron P, having a solid content of 1.3% by mass) was applied onto the surface of the transparent conductive layer (electrode) in a mode of spin coating and then dried in vacuum at 150° C. for 2 hours to thereby form a hole-transporting organic thin layer having a thickness of 100 nm. This is a substrate X.

On the other hand, on one surface of a temporary support of polyether sulfone (Sumitomo Bakelite's Sumilite FS-1300) having a thickness of 188 μm, a light-emitting organic thin film layer-forming coating solution having a composition mentioned below was applied by the use of a spin coater, and dried at room temperature to thereby form a light-emitting organic thin film layer having a thickness of 13 nm on the temporary support. This is a transfer material Y.

| | | |
|---|---|---|
| Polyvinyl carbazole (Mw = 63000, by Aldrich) | 40 | parts by mass |
| Tris(2-phenylpyridine)/indium complex | 1 | part by mass |
| (orthometalated complex) | | |
| Dichloroethane | 3200 | part by mass |

The substrate X and the transfer material Y were placed one upon another in such a manner that the organic thin film layer of the former could be in contact with the light-emitting organic thin film layer of the latter, heated by the use of a pair of hot rollers at 160° C. under a pressure of 0.3 MPa and at a speed of 0.05 m/min. Then, the temporary support was peeled off, and the light-emitting organic thin film layer was formed on the top of the substrate X. This is a substrate XY.

On the other hand, on one surface of a 50 μm-thick polyimide film (Ube Kosan's Upilex-50S) cut in a size of 25 mm square, a patterned mask was set for vapor deposition (the mask restricts the light-emitting area to 5 mm×5 mm), and Al was deposited onto the film in a mode of vapor deposition under a reduced atmosphere of about 0.1 mPa to thereby form an Al electrode having a film thickness of 0.3 μm. Using a target thereof, Al₂O₃ was deposited on the Al layer in the same pattern as that of the Al layer (Al electrode), in a mode of vapor deposition according to a DC magnetron sputtering process. Thus formed, the Al₂O₃ layer had a thickness of 3 nm. An aluminium lead wire was fitted to the Al electrode, and a laminate structure was thus constructed. An electron-transporting organic thin film layer-forming coating solution having a composition mentioned below was applied onto the laminate structure by the use of a spin coater, and dried in vacuum at 80° C. for 2 hours to thereby form thereon an electron-transporting organic thin film layer having a thickness of 15 nm. This is a substrate Z.

| | |
|---|---|
| Polyvinyl butyral 2000 L (Mw = 2000, | 10 parts by mass |
| by Denki Kagaku Kogyo) | |
| 1-Butanol | 3500 parts by mass |
| Electron-transporting compound having | 20 parts by mass |
| the following structure: | |

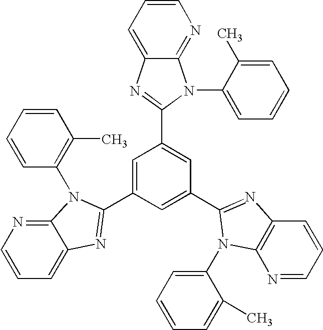

The substrate XY and the substrate Z were placed one upon another in such a manner that the electrodes of the two could face each other via the light-emitting organic thin film layer sandwiched therebetween, and laminated under heat by the use of a pair of hot rollers at 160° C. under a pressure of 0.3 MPa and at a speed of 0.05 m/min. The process gave organic EL devices F-1 and F-2 from the optical films P-1 and P-2, respectively.

Using a source measure unit Model 2400 (by Toyo Technica), a direct current voltage was applied to the organic EL devices F-1 and F-2, and the organic EL devices F-1 and F-2 of the invention both emitted light.

The above-mentioned Examples confirm that the optical film of the invention has good heat resistance and good transparency. In addition, a gas-barrier layer and a transparent conductive layer can be laminated on the film, and even though the film is subjected to heat treatment assuming the disposition of TFT thereon, it still functions as a substrate film for organic EL devices.

The optical film of the invention has good heat resistance and good optical properties, and therefore, optionally after coated with various functional layers formed thereon, it may be used in image display devices such as flat panel display devices including liquid-crystal displays, plasma displays, electroluminescent (EL) displays, fluorescent character display tubes and light-emitting diodes. In addition, the optical film of the invention is usable in solar cells and touch panels.

1. A polymer having a recurring unit of the following formula (1):
formula (1) 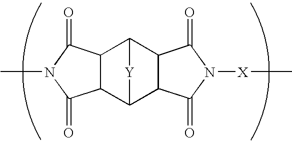
wherein X represents a divalent linking group of the following formula (2); and Y represents a methylene group, an ethylene group or an ethenylene group:
formula (2) 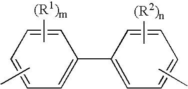
wherein R¹ and R² each independently represent at least one selected from the group consisting of a halogen atom, a substituted or unsubstituted alkyl group, a substituted or unsubstituted alkoxy group, and a substituted or unsubstituted aryl group; and m and n each independently indicate an integer of from 0 to 4.

2. The polymer as claimed in claim 1, which has a glass transition temperature not lower than 350° C.

3. The polymer as claimed in claim 1, which has a weight-average molecular weight of from 20,000 to 500,000.

4. The polymer as claimed in claim 1, wherein Y in formula (1) is a methylene group.

5. The polymer as claimed in claim 1, wherein Y in formula (1) is an ethylene group.

6. The polymer as claimed in claim 1, wherein Y in formula (1) is an ethenylene group.

7. The polymer as claimed in claim 1, wherein R¹ and R² in formula (2) each are independently a halogen atom, or a substituted or unsubstituted alkyl group.

8. The polymer as claimed in claim 1, wherein m and n formula (2) each are independently 1 or 2.

9. The polymer as claimed in claim 1, wherein the molar percentage of the recurring unit of formula (1) is from 50 to 100 mol %.

10. The polymer as claimed in claim 1, which comprises only the recurring unit of formula (1).

11. A method for producing a polymer having a recurring unit of the following formula (1), which comprises condensing a tetracarboxylic acid or its derivative with a diaminobiphenyl derivative: 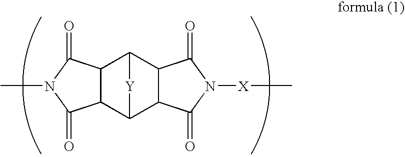
wherein X represents a divalent linking group of the following formula (2); and Y represents a methylene group, an ethylene group or an ethenylene group: 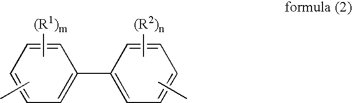
wherein R¹ and R² each independently represent at least one selected from the group consisting of a halogen atom, a substituted or unsubstituted alkyl group, a substituted or unsubstituted alkoxy group, and a substituted or unsubstituted aryl group; and m and n each independently indicate an integer of from 0 to 4.

12. The production method as claimed in claim 11, wherein the condensation is carried out in the presence of triphenyl phosphite in an organic polar solvent.

13. An optical film comprising a polymer that has a recurring unit of the following formula (1): 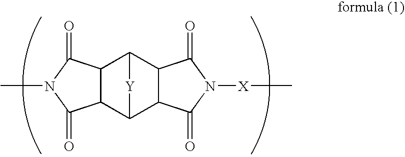
wherein X represents a divalent linking group of the following formula (2); and Y represents a methylene group, an ethylene group or an ethenylene group: 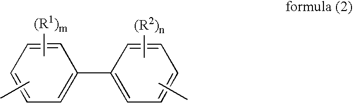
wherein R¹ and R² each independently represent at least one selected from the group consisting of a halogen atom, a substituted or unsubstituted alkyl group, a substituted or unsubstituted alkoxy group, and a substituted or unsubstituted aryl group; and m and n each independently indicate an integer of from 0 to 4.

14. The optical film as claimed in claim 13, wherein the polymer has a glass transition temperature not lower than 350° C.

15. The optical film as claimed in claim 13, which, when having a thickness of 50 μm, has a light transmittance at a wavelength of 420 nm of at least 80%.

16. The optical film as claimed in claim 13, which is stretched.

17. An optical film having a gas-barrier layer, wherein the gas-barrier layer is formed on the optical film of claim 13.

18. An optical film having a transparent conductive layer, wherein the transparent conductive layer is formed on the optical film of claim 13.

19. An image display device comprising the optical film of claim 13.

20. The image display device as claimed in claim 19, which is an organic EL device.
